(19) United States
(12) Patent Application Publication
(10) Pub. No.: US 2012/0129415 A1
(43) Pub. Date: May 24, 2012

(54) Destructive Disposal of Medical Active Ingredients in Transdermal Therapeutic Systems

(76) Inventors: Margit Wirz, Polch (DE); Thomas Hille, Neuwied (DE)

(21) Appl. No.: 13/388,829

(22) PCT Filed: Jul. 29, 2010
(86) PCT No.: PCT/EP10/04641

§ 371 Date: Feb. 7, 2012

(30) Foreign Application Priority Data
Aug. 7, 2009 (DE) 10 2009 036 485.4

(51) Int. Cl. B32B 5/16

(52) U.S. Cl. 442/181; 428/221; 442/304; 442/327

(57) ABSTRACT

The invention relates to a multilayered structure used in the destructive disposal of medical active ingredients contained in transdermal therapeutic systems (=TTS). The structure has a multi-layer design and contains at least one layer having agents embedded therein and at least one fiber layer. It may additionally include a protective layer. The structure according to the invention is stored separately from the TTS. The separately stored structure is brought into contact with the TTS after use of the TTS.

The invention relates to a means for the destructive disposal of medical active ingredients, also referred to for short hereinafter as drug form, which are present in transdermal therapeutic systems (TTS), in certain cases also referred to as transdermal patches. The means of the invention is contacted with the TTS after use, thereby causing the drug form to be decomposed or destroyed in a chemical reaction, but in any case robbing it of its medical effect. The TTS itself normally comprises as drug form an active therapeutic ingredient, preferably one from the group of the analgesics, which is carried to the skin from the system by diffusion and is then administered transdermally for therapeutic purposes.

Transdermal applications with the medical active ingredients buprenorphine and fentanyl are the drug forms of choice for the treatment of chronic pain in long-term therapy. The continuous delivery of such highly active analgesics via the skin over a relatively long time provides a continuous supply of a constant dose of analgesic to a patient with pain, thereby preventing plasma peaks and plasma troughs. This has the advantage that, by virtue of a low but sufficient plasma concentration of the active ingredient, there is occurrence neither of side effects due to overdose nor of avoidable states of pain due to undersupply. The skilled person is aware, for example, of the commercial products Transtec®, but also Durogesic® or Durogesic® Smat, which have proven useful in the therapy of pain for a considerable time.

The disadvantage of the TTS in the therapy of pain, however, is that in order to maintain the so-called concentration gradient and hence the therapeutically desired plasma level of the medical active ingredient throughout the period of administration of the TTS, it is always necessary for the store quantity of active ingredient present in the TTS to be greater than that actually delivered to the patient. A consequence of this is that TTS which are used or have been worn constitute a potential for abuse by, for example, those involved in the drugs scene. These groups of persons are perfectly capable of collecting worn TTS and extracting the residual medical active ingredient still present, and of consuming it abusively in order to appease their drug addiction.

Such considerations also apply in a similar vein to the hormone testosterone or the sympathomimetic methylphenidate. In order to avoid plasma peaks and plasma troughs, both drugs are advantageously administered transdermally and harbor a certain potential for abuse, which is why, for example, methylphenidate is considered worldwide to be a narcotic. In the USA, testosterone is subject to similar legal provisions as narcotics.

In the past, therefore, there has been no deficiency of attempts to prevent this uncontrolled misuse, by advising patients to shed worn patches and then put them down the toilet into the sewerage system. A disadvantage of this method is that the mass disposal of drugs through the sewerage system represents an environmental problem which should not be underestimated. Furthermore, there is a risk of outflow pipes becoming clogged by low-solubility TTS carrier materials.

Consequently, TTS were developed which as well as the active ingredient also contained an antagonist (e.g., WO 2004/098576, WO 90/04965, WO 2004/037259). The intention thereby was to prevent, or at least significantly hinder, the above-described obtaining or abusive extraction of the medical active ingredient from used TTS. These protective measures, however, proved not to be enough to prevent drug misuse, since it continues to be the case that the medical active ingredient itself can be separated from the antagonist, in theory and in fact by relatively simple means, by fractional precipitation.

WO 2007/137732 describes a TTS which in addition to an active ingredient further comprises an agent, which is separate from the active ingredient and which makes the active ingredient useless, in a solution. Additionally present to this end is a means which, following use of the TTS, allows the agent to enter into contact with the active ingredient and make it useless. The disadvantage of this otherwise ideal solution, however, is that the agent in solution, on account of its high reactivity, restricts the shelf life, and that, in some cases, the risk exists of damage by liquid leakage in the course of transportation as well.

DE 10 2008 016 804, unpublished at the priority date of the present specification, has already proposed a TTS which following its use, in other words following its detachment from the surface of the patient's skin by the patient, undergoes self-destruction. A self-destructing TTS in the sense of this earlier development means that the residual medical active ingredient present in the TTS, after use, is directly or indirectly destroyed, chemically decomposed and/or rendered useless. In the case of the embodiment proposed, it has also been ensured, to the utmost possibility, that the process of destruction does not begin even before or even during the transdermal administration of the TTS. A disadvantage of this embodiment, however, is the technically complicated manufacturing procedure, which constitutes a problem from the economic standpoint.

The object on which the present invention was based, therefore, was that of providing a means by which, following proper use of a TTS, reliably and completely prevents the abusive removal of residual medical active ingredient. The means ought additionally to be easy to produce and to be able to be stored without problems for a relatively long time period. Furthermore, the means should combine easy of handling by the user of the TTS with high reliability of its effect.

This object is achieved by a means of the above-specified type whose characterizing features are to be seen in the fact that it possesses a multilayer structure, that it comprises at least one layer with agent incorporated therein, and that it comprises at least one fiber layer.

In one preferred embodiment, the means of the invention further comprises a protective layer. It is stored separately from the drug form. The means of the invention, stored separately from the drug form, is contacted with the drug form after said drug form has been used.

The agent incorporated into the layer of the means of the invention may be one substance or a substance mixture which in accordance with the invention may be present in the form of a solid or a paste. The agent is preferably a substance which reacts chemically with the medical active ingredient, the drug form, and thereby destroys it. This effect is obtained in particular by chemical oxidizing agents such as, for example, inorganic reagents, such as permanganates, e.g., potassium permanganate, manganese dioxide, lead dioxide, lead tetraacetate, cerium(IV) salts, chromates, osmium tetroxide, nitrites, such as potassium nitrite, selenium dioxide, peroxo compounds, hypohalides, or sulfur; of these, preference is given to potassium permanganate and potassium nitrite. Organic oxidants, such as dimethyl sulfoxide, N-bromosuccinimide, quinones, hypervalent iodine compounds, peracids and peresters, and also enzymes, may likewise be employed. For a given medical active ingredient, the agent is selected preferably on the basis of its chemical reactivity with the active ingredient. The skilled person is generally aware of which agent is most suitable for which drug form in the sense of the invention.

The medical active ingredient is preferably an active ingredient from the group of analgesics such as, for example, narcotics. Mention may preferably be made of morphine derivates, heroin and buprenorphine, or fentanyl and its derivatives sufentanil and alfentanil. In principle, all other combinations of active ingredient and agent can be used for which transdermal administration via a TTS is an appropriate administration form—examples include testosterone and methlyphenidate.

The means of the invention with multilayer construction comprises at least one layer into which the agent is incorporated. This may be a polymeric layer or a pressure-sensitive adhesive layer. Polymers which can be used for this purpose are standard polymers, such as, for example, polyamide, polyimide, polytetrafluoroethylene, polyethylene, polypropylene, polyvinyl chloride, polyacrylates or polymethacrylates, polystyrene or polyesters. Incorporation is achieved such that the agent can easily be dissolved out of the polymeric layer again in order to fulfill its intended purpose, the destructive disposal of the drug form.

As a pressure-sensitive adhesive layer, in accordance with the invention, adhesives are employed which are permanently tacky or remain sticky at room temperature without solvent and which adhere to virtually any substrates under gentle applied pressure. A preferred basis for suitable pressure-sensitive adhesives are natural or synthetic rubbers, polyacrylates, polyesters, polychloroprenes, polyisobutenes, polyvinyl ethers or polyurethanes, which for their intended purpose are normally used in combination with natural or synthetic resins and with oxidation stabilizers. In the case of the pressure-sensitive adhesive layer, the agent is incorporated by scatter application. Accordingly, the agent can easily be dissolved out of the pressure-sensitive adhesive layer again.

The means of the invention with multilayer construction further comprises at least one fiber layer. This may be a woven fabric, a knitted fabric or a nonwoven fabric composed of mineral fibers, such as glass, mineral wool, basalt, animal fibers such as silk or wool, plant fibers such as cotton, or chemical fibers made of natural (e.g., cellulose) and/or synthetic polymers. As synthetic plastics it is possible here to use standard polymers as for the polymeric layer, namely polyamide, polyimide, polytetrafluoroethylene, polyethylene, polypropylene, polyvinyl chloride, polyacrylates or polymethacrylates, polystyrene or polyesters.

In one preferred embodiment the means of the invention further comprises a protective layer. The protective layer is in this case disposed on the free surface of the polymer layer in other words the side opposite the fiber layer. Employed as a protective layer in accordance with the invention more particularly are films of plastic, such as of polyethylene, of polypropylene or of polyester, for example.

The means of the invention may additionally comprise a further adhesive layer for attachment of the protective layer, this being especially useful when the layer into which the agent is incorporated is not itself a pressure-sensitive adhesive layer.

For its intended use, the destructive disposal of the medical active ingredient, the means of the invention with multilayer construction, stored separate from the drug form, is contacted with the drug form. The way in which this occurs is that, following the removal of the transdermal patch/TTS from the patient's skin, the fiber layer of the means of the invention is moistened with a small amount of liquid. The TTS which has been worn is then adhered to the moistened fiber layer of the means of the invention with multilayer construction. The liquid passes through the fiber layer to the agent incorporated in the polymeric layer, where it dissolves the agent from said layer, and so causes the agent to diffuse back through the fiber layer and thus come into direct contact with the medical active ingredient, thereby subjecting it to chemical destruction.

The means of the invention for the destructive disposal of medical active ingredients in TTS with multilayer construction is suitable for all known TTS; for the production of such TTS, the skilled person in principle employs the materials, production methods, and construction of the TTS or transdermal patches known from the prior art (in this regard, cf.: Transdermale Pflaster; Spektrum der Wissenschaft 10/2003, 42; Transdermal Controlled Systemic Medications, Y. W. Chien, Drugs and the Pharmaceutical Sciences, Vol. 31; Polymers in Transdermal Drug Delivery Systems, S. Kandavilli et. al., Pharmaceutical Technology, May 2002, 62-80).

The invention is elucidated in more detail by the working example below, without being restricted to the individual embodiment and selection of material described therein. It is nevertheless possible for specific embodiments, described in the examples, of the means of the invention for the destructive disposal of medical active ingredients in TTS to be generalized as such, individually or in combination with one another, as preferred features for the invention.

### EXAMPLE 1

In ethyl acetate, neutral polymethacrylate (Plastoid B) was dissolved in a fraction such as to produce a polymer solution having a solids content of 40% by weight. Following complete dissolution of the polymer, the same weight fraction of fine-grained potassium permanganate was suspended therein at room temperature with stirring. The resulting polymer solution was applied using a suitable coating bar to a siliconized polyester film. The solvent was subsequently removed at a temperature of 60° C. in a laboratory drying cabinet known to the skilled person. Following the removal of the solvent, the weight per unit area was 180 g/m².

In a mechanical operation, individual segments were punched from the dried laminate web, with approximately the size of commercial Transtec® TTS (70 times 70 mm). Lastly, the polymeric layer with incorporated potassium permanganate was covered with a nonwoven web of random-laid cellulose fibers.

As a test, three means of the invention produced in this way, with multilayer structure, were trialed on TTS comprising buprenorphine as medical active ingredient, over various exposure times. For this purpose, the nonwoven web was moistened with 4.5 ml of water, and the TTS was adhered to the moistened nonwoven web. After the exposure time indicated in the table below, the TTS was separated from the nonwoven web and the residual buprenorphine was dissolved out using isopropanol plus 0.1% ascorbic acid. The amount of residual active ingredient was determined by means of high-pressure liquid chromatography (HPLC).

The results are collated in the table below.

| Specimen | Exposure time | Amount | Recovery |
|---|---|---|---|
| Bph20 as | ./. | 20.3 | 101.3 |
| Bph20 | 0.5 h | 17.3 | 86.3 |
| | 1 h | 16.1 | 80.7 |
| | 2 h | 10.5 | 52.5 |
| | 3 h | 2.7 | 13.3 |
| | 5 h | 0.2 | 1.0 |
| | 6 h | 0.2 | 1.0 |

It was clearly apparent that after an exposure time of 3 to 4 hours, any significant amount of medical active ingredient was no longer detectable. Consequently, the means of the invention has completely achieved its purpose of destructive disposal, and thereby effectively prevented abusive re-use for an ulterior purpose.

1. A means for the destructive disposal of medical active ingredients present in transdermal therapeutic systems comprising a multilayer construction, wherein the means comprises at least one layer with agent incorporated therein and at least one fiber layer.

2. The means as claimed in claim 1, wherein the means further comprises a protective layer.

3. The means as claimed in claim 1, wherein the means is stored separate from the medical active ingredient intended for destructive disposal.

4. The means as claimed in claim 3, wherein the separately stored means is contacted with the transdermal therapeutic system after said system has been used.

5. The means as claimed in claim 1, wherein said means comprises the agent in solid or pastelike form.

6. The means as claimed in claim 1, wherein the agent is an oxidizing agent.

7. The means as claimed in claim 1, wherein the agent is potassium permanganate or potassium nitrite.

8. The means as claimed in claim 1, wherein the layer with agent incorporated therein is a polymeric layer with agent incorporated therein or a pressure-sensitive adhesive layer with agent incorporated therein.

9. The means as claimed in claim 8, wherein the polymeric layer with agent incorporated therein comprises polyamide, polyimide, polytetrafluoroethylene, polyethylene, polypropylene, polyvinyl chloride, polyacrylates or polymethacrylates, polystyrene or polyesters.

10. The means as claimed in claim 8, wherein the pressure-sensitive adhesive layer with agent incorporated therein comprises pressure-sensitive adhesives based on natural or synthetic rubber, on polyacrylate, on polyester, on polychloroprene, on polyisobutene, on polyvinyl ether or on polyurethane.

11. The means as claimed in claim 1, wherein said fiber layer is a woven fabric, a knitted fabric or a nonwoven fabric made from mineral fibers, from animal fibers, from plant fibers or from chemical fibers comprised of natural or synthetic polymers.

12. The means as claimed in claim 1, wherein said means further comprises a protective layer disposed on a free surface of the layer with agent incorporated therein, wherein said surface is opposite the fiber layer.

13. The means as claimed in claim 12, wherein said protective layer is a plastic film.

14. The means as claimed in claim 10, wherein the pressure-sensitive adhesives are combined with natural or synthetic resins and with oxidation stabilizers.

15. The means as claimed in claim 11, wherein said mineral fibers are glass, mineral wool or basalt; said animal fibers are silk or wool; said plant fibers are cotton and said polymers are polyamide, polyimide, polytetrafluoroethylene, polyethylene, polypropylene, polyvinyl chloride, polyacrylate, polymethacrylate, polystyrene or polyester.

16. The means as claimed in claim 13, wherein said plastic film is a polyethylene, polypropylene or polyester film.
